(19) United States
(12) Patent Application Publication
(10) Pub. No.: US 2011/0136238 A1
(43) Pub. Date: Jun. 9, 2011

(54) OXYGEN INDICATOR

(75) Inventors: Eero Hurme, Espoo (FI); Thea Sipiläinen-Malm, Espoo (FI)

(73) Assignee: Teknologian tutkimuskeskus VTT, Espoo (FI)

(21) Appl. No.: 12/999,220

(22) PCT Filed: Jun. 17, 2009
(86) PCT No.: PCT/FI2009/050534

§ 371 Date: Feb. 16, 2011

(30) Foreign Application Priority Data
Jun. 18, 2008 (FI) 20085609

(51) Int. Cl. G01N 31/22; B05D 3/02; B05D 5/06

(52) U.S. Cl. 436/1; 427/226

(57) ABSTRACT

The invention relates to a dye composition comprising a dye, dye converter, binder, reducing agent, solvent and optionally basic agent. Further, the invention relates to a method for fabricating an oxygen indicator wherein a dye composition is applied over a substrate and reduced by heating, to an oxygen indicator fabricated by the method and to a package for detecting a leakage and/or variation in the oxygen content.

### FIELD OF THE INVENTION

The invention relates to a dye composition, a method for fabricating an oxygen indicator, an oxygen indicator fabricated by the method, and a package for detecting a leakage and/or variation in the oxygen content.

### BACKGROUND OF THE INVENTION

To detect variation in the oxygen content of a package, it is known to use an indicator comprising a dye that changes color due a reduction-oxidation reaction, thereby indicating variation in the package conditions. Publications JP2007168817 and FI 20050809 disclose oxygen indicators based on a reduction-oxidation color reaction, which are reduced by heating and which are suitable for sterilized product packages.

A problem with these oxygen indicators is water-solubility of the dye composition, which makes it more difficult to combine it with the package material/substrate. In addition, an indicator based on a water-soluble dye composition may dissolve in water and possibly in aqueous products, unless it has been protected for example by a waterproof cover.

Publication EP 1312918 discloses an oxygendetecting composition comprising layered silicate, cationic surfactant, organic colorant, reducing agent and optionally a basic substance. The composition indicates the presence of oxygen by a color change. The indicator composition can be used as printing ink.

A problem with the known indicator composition is the silicate, which is insoluble. The solid particles provide stability problems, and a composition comprising such particles cannot be printed for example by the inkjet technique.

### OBJECTIVE OF THE INVENTION

The objective of the invention is to eliminate the drawbacks referred to above.

One objective of the invention is to disclose a water-resistant oxygen indicator and a dye composition in which the components of the solvent-soluble dye composition are uniformly distributed in the solvent and which provides a high quality print and coating result.

Another objective of the invention is to disclose an oxygen indicator and a dye composition which exhibit suitable heat resistance for sterilized or generally heated product packages.

### SUMMARY OF THE INVENTION

The dye composition according to the invention is characterized by what has been presented in claim 1.

The method for fabricating an oxygen indicator and the oxygen indicator according to the invention are characterized by what has been presented in claims 10 and 13.

The package according to the invention is characterized by what has been presented in claim 17.

The dye composition according to the invention comprises a dye, dye converter, binder, reducing agent, solvent and optionally basic agent.

Oxidation and reduction dyes known in the art and/or mixtures thereof may be used as the dye. Any dye which oxidizes and changes color by the effect of oxygen, is solvent-soluble or may be brought to the soluble form and exhibits good heat resistance is possible. Such a dye may be selected for example from indigo dyes such as indigo and indigo carmine, and/or the like.

Preferably, indigo carmine is used as the dye.

The dye converter forms together with the dye a solvent-soluble dye derivative which is insoluble in water. Quaternary ammonia salts with four saturated, unsaturated and/or aromatic hydrocarbon groups, from which a part or all may be halogenated, may be used as the dye converter.

Preferably, hexadecyl trimethyl ammonium bromide is used as the dye converter.

The binder binds the components of the dye composition together and fastens the indicator on a substrate, the surface to be printed. The binder may be selected according to the bedding to be printed and to be suitable for the printer. Solvent-soluble polymeric material such as a solvent-soluble polymer wherein the starting materials may include for example butadiene, styrene, vinyl acetate, vinyl butyrate, acrylic acid, methacrylic acid and/or their esters, solvent-soluble polyketone, solvent-soluble cellulose derivatives and/or mixtures thereof may be used as the binder.

Preferably, polyvinyl butyrate, polyketone and/or a mixture thereof is used as the binder.

Reducing sugars such as mono- and/or disaccharides are used as the reducing agent. Dextrose, fructose, xylose and/or maltose may be used as the reducing mono- and/or disaccharides.

The reducing sugar is preferably dextrose.

The solvent used in the dye composition according to the invention is intended to make the structure of the dye composition completely dissolved. Optionally, a substituted alcohol such as methanol, ethanol, methoxy ethanol, isopropyl alcohol etc., polyvalent alcohols e.g. propylene glycol and glycerol and their derivatives, ketone such as methyl ethyl ketone etc., aromatic hydrocarbons such as toluene, xyleve, ester such as ethyl acetate and/or any equivalent solvent which dissolves all of the components of the dye composition, or mixtures thereof, may be used as the solvent. Preferably alcohol and more preferably methanol, ethanol, methoxy ethanol and/or their mixture is used as the solvent. The solvent may comprise a small amount of water.

The basic agent may be used to enhance the reduction efficiency of the reducing agent. Solvent-soluble hydroxides and/or carbonates such as solvent-soluble hydroxides and/or carbonates of alkali metals and alkali earths and/or ammonia may be used as the basic agent.

Preferably, ammonium hydroxide such as tetrabutyl ammonium hydroxide is used as the basic agent.

The dye composition according to the invention may also comprise additives generally used in dye compositions and indicators such as a surfactant, enzyme, softener, wax etc.

The oxygen indicator is fabricated by preparing a solvent-soluble dye derivative which is insoluble in water by mixing a dye and a dye converter; by preparing a dye composition by mixing the dye derivative, binder, reducing agent, solvent and optionally basic agent; by applying the dye composition over a substrate; and by reducing the dye composition by heating. The dye derivative which is insoluble in water and the dye composition are prepared by conventional preparation/mixing techniques of dye derivatives and dyes.

The solvent-soluble dye derivative which is insoluble in water is preferably indigo carmine hexadecyl trimethyl ammonium bromide.

Then, the mixture is applied over a substrate and the dye composition is reduced by heating in an atmosphere containing as small amount of oxygen as possible. Other additives may be added to the dye composition if desired at the mixing stage before application.

The dye composition may be applied over a substrate by any known coating or printing technique such as flexographic, screen, gravure printing, offset or inkjet technique.

The dye composition printed on a substrate is reduced by heating at an elevated temperature, for example sterilization temperature, typically at a temperature of 100 to 165° C., more preferably at a temperature of 120 to 130° C. Reduction carried out by thermal treatment is well suited for sterilizable products and packages.

The dye composition may be printed directly on a substrate forming the package material. In this case, the dye composition is printed directly on the package at the time of packaging.

The dye composition may also be printed over a substrate forming a separate bedding which is added to the package at the time of packaging. The material of a separate bedding is typically one of the belowmentioned substrate and package materials. A separate bedding is preferably in the form of a sticker which can be easily added to the package in connection with packaging the product. The separate bedding may also be for example an oxygen scavenger pouch or sticker.

The employed substrate and package material may be a package material based on chemical pulp, plastic and/or glass and/or any other generally used package material. The material based on chemical pulp may be for example surface-treated or untreated paper, board, film material based on dissolving pulp or other material based on chemical pulp. The plastic material may be for example polyethene, polypropene, other polyolefin, polyester, polystyrene, polyamide or any other plastic material generally used as package material. Further, the substrate and package material may be formed by a laminate or other type of composite of the above-mentioned or other known package materials. The material may also be coated.

The indicator/dye composition is added to a package before the package is closed, and it is reactive immediately after the product has been packaged and heated. The indicator added to a package reacts to oxygen brought into the package from outside, indicating through color change that the package has trans-mitted oxygen or that the oxygen scavenger does not work properly. Furthermore, the indicator reacts to oxygen which has accessed due to breaking of the package, indicating a leakage.

The color change of the oxygen indicator may be detected at the visible light wavelength range of 400 to 780 nm or at the UV radiation wavelength range of 100 to 400 nm. The color change of the indicator may be read visually or automatically by optical or other reading techniques without breaking the package.

The oxygen indicator and the package may be used for packaging preferably foodstuffs, drugs, cosmetic products or products of technical chemistry to indicate correct storage and high quality of the products.

When the indicator is used in connection with a bar code identifier or other optical identification code in a package, any oxygen brought into the package through ageing and/or breaking of the package induces a color change which eventually inactivates the identifier, i.e. makes it possible to read and/or identify it. This prevents e.g. the sales of an expired and/or broken package in a store.

The invention enables fabrication of a reliable, irreversible oxygen indicator which is operational immediately after packaging and heating, is water-resistant and endures high temperatures used with sterilizable products. Furthermore, the dye composition according to the invention can be easily combined with the package material by printing it directly on the surface of the package material as a disposable indicator using for example the dripping technique. The dye composition/indicator may be printed on the surface of the package material in one working step. In addition, the dye composition and the indicator according to the invention provide a sensitive and distinct color reaction, and the components and fabrication of the indicator are inexpensive. The amounts of reactants required to fabricate the oxygen indicator are very small.

### DETAILED DESCRIPTION OF THE INVENTION

### Example

A test was carried out to study the effect of the components of the dye composition on the color change of the indicator at the sterilization temperature (121° C.), and the color change of the indicator by the effect of oxygen.

Dye composition A according to the invention which was printed manually by a Hand Coater rod on a PP film, and dye composition B which was printed by inkjet DMP-2800 on a PP film were used in the test.

The dye compositions were prepared from the components presented in Table 1 by first preparing a dye derivative from indigo carmine and hexadecyl trimethyl ammonium bromide. Then, solutions of the dye derivative, binder, reducing sugar and base were prepared separately. Finally, these were mixed together. Also 0.05% of a fluorohydrocarbon-based surfactant was added to the binder solution of dye composition B.

TABLE 1

Dye composition

| | A | B |
|---|---|---|
| Dye derivative/solvent: | | |
| Indigo carmine - hexadecyl trimethyl | 2000 μl | 6000 μl |
| ammonium bromide/methanol | | |
| (10 mg/1 ml) | | |
| binder/solvent: | | |
| polyvinyl butyral PVB/methanol | 5000 μl | |
| (20% solution) | | |
| PVB/50% methanol + 50% methoxy | | 4500 μl |
| ethanol (20% solution) | | |
| reducing sugar/solvent: | | |
| dextrose/methanol saturated solution | 150 μl | 225 μl |
| basic solution: | | |
| 40% solution of tetrabutyl ammonium | 100 μl | 150 μl |
| hydroxide in water | | |

To examine the performance of the indicator, the fabricated indicator films were cut into equally large (2 cm×2 cm) pieces which were fastened by tape on the inner surface of pouches (Amcor OPA15/AloxPET12/CPP100) prepared for sterilization. Also an oxygen absorbent (Atco HV210) was inserted in the pouch and it was filled with protective gas (100% N₂). The packages were autoclaved in 24 hours at 121° C. for 60 min. After autoclaving, the packages were stored for 2 d at different temperatures, in a refrigerator at 8° C., at a temperature of 20° C. and 40° C. The packages were opened and the color change of the indicators was observed visually.

The results are presented in Table 2.

TABLE 2

| | Indicator | | | |
|---|---|---|---|---|
| | A, 8° C. | A, 20° C. | A, 40° C. | B, 20° C. |
| color before | blue | blue | | blue |
| autoclave | | | | |
| color after | colorless | colorless | colorless | faintly |
| autoclave | | | | yellow |
| color after | colorless | colorless | colorless | 3 d: faintly |
| 2 d from autoclave | | | | yellow |
| color after | faintly | faintly | faintly | 10 min: |
| 5 min from | bluish | bluish | bluish | bluish |
| opening the | | | | |
| pouch | | | | |
| color after | bluish | bluish | bluish | bluish |
| 1 h from | | | | |
| opening the | | | | |
| pouch | | | | |
| color after | blue | blue | blue | bluish |
| 4 d from | | | | |
| opening the | | | | |
| pouch | | | | |

The color change induced by oxygen is irreversible. The substance ratios of the components of the dye composition affect the sensitivity and distinctiveness of the color reaction.

The invention is not limited merely to the exemplary embodiments referred to above; instead, many variations are possible within the scope of the inventive idea defined by the claims.

1. A dye composition comprising a dye, dye converter, binder, reducing agent, solvent and optionally basic agent.

2. The dye composition according to claim 1, wherein the dye is a reduction-oxidation dye such as indigo dye, preferably indigo carmine.

3. The dye composition according to claim 1 wherein the dye converter is a quaternary ammonia salt such as hexadecyl trimethyl ammonium bromide.

4. The dye composition according to claim 1, wherein the binder is a solvent-soluble polymeric material.

5. The dye composition according to claim 1, wherein the binder is polyvinyl butyral and/or polyketone.

6. The dye composition according to claim 1, wherein the reducing agent is a reducing sugar such as dextrose.

7. The dye composition according to claim 1, wherein the solvent is alcohol, ketone, ester and/or their mixture.

8. The dye composition according to claim 1, wherein the solvent is methanol, ethanol, methoxy ethanol and/or their mixture.

9. The dye composition according to claim 2, wherein the basic agent is ammonium hydroxide such as tetrabutyl ammonium hydroxide.

10. A method for fabricating an oxygen indicator, in which method
a solvent-soluble dye derivative which is insoluble in water is prepared by mixing a dye and a dye converter,
a dye composition is prepared by mixing the dye derivative, binder, reducing agent, solvent and optionally a basic agent,
the dye composition is applied over a substrate,
and the dye composition is reduced by heating.

11. The method according to claim 10, wherein the dye composition applied over a substrate is reduced at a temperature of 100 to 165° C., preferably at a temperature of 120 to 130° C.

12. The method according to claim 10, wherein the application is carried out by printing.

13. An oxygen indicator fabricated by the method according to claim 10.

14. The oxygen indicator according to claim 13, wherein the substrate is package material.

15. The oxygen indicator according to claim 13, wherein the substrate is a separate bedding added to a package.

16. The oxygen indicator according to claim 13, wherein it indicates a leakage and/or variation in the oxygen content by a color change.

17. A package for detecting a leakage and/or variation induced by the oxygen content, wherein the package is formed by adding the indicator according to claims 13 to 16 to the package at the time of packaging.

18. The package according to claim 17, wherein the package is a package for food, drug or cosmetics products or for the products of technical chemistry.
